(19) United States
(12) Patent Application Publication
(10) Pub. No.: US 2026/0163036 A1
(43) Pub. Date: Jun. 11, 2026

(54) Method and Apparatus for Controlling a Power Transmission Device and a Fuel Cell Power System

(71) Applicant: Robert Bosch GmbH, Stuttgart (DE)

(72) Inventor: Lina Xu, Wuxi (CN)

(21) Appl. No.: 19/407,657

(22) Filed: Dec. 3, 2025

(30) Foreign Application Priority Data
Dec. 6, 2024 (CN) 2024 1179 3119.9

(51) Int. Cl. H01M 8/04858; H01M 8/04302; H01M 8/04303; H01M 8/0444; H01M 8/04537

(52) U.S. Cl. CPC H01M 8/0491; H01M 8/04302; H01M 8/04303; H01M 8/0447; H01M 8/04559; H01M 2250/20

(57) ABSTRACT

A method and apparatus for controlling a power transmission device and a fuel cell power system are disclosed. The method includes (i) acquiring a sensing signal indicating an output voltage of a fuel cell power supply, the fuel cell power supply providing power to other devices via a power transmission device, (ii) comparing the output voltage indicated by the sensing signal to at least one of a high voltage threshold and a low voltage threshold, the voltage range between the high voltage threshold and the low voltage threshold representing a range of expected output voltages of the fuel cell power supply, and (iii) in response to the output voltage being not lower than the high voltage threshold, controlling the power transmission device to increase the current input from the fuel cell power supply to the power transmission device, or in response to the output voltage being not higher than the low voltage threshold, controlling the power transmission device to reduce the current input from the fuel cell power supply to the power transmission device. In this way, the lifespan and performance of fuel cells can effectively be improved.

This application claims priority under 35 U.S.C. § 119 to application no. CN 2024 1179 3119.9 filed on Dec. 6, 2024 in China, the disclosure of which is incorporated herein by reference in its entirety.

The present disclosure relates to the fields of fuel cells and power electronics, and more particularly, to a method and apparatus for controlling a power transmission device and a fuel cell power system.

### BACKGROUND

With the intensification of global environmental problems and the gradual depletion of fossil energy, new energy vehicles are developing rapidly and gradually replacing traditional fuel vehicles. A fuel cell vehicle is a new energy vehicle that uses fuel cells as its main energy source. In fuel cells, fuels such as hydrogen and oxygen react chemically to generate electrical energy, and almost no pollutants are produced, making them highly environmentally friendly.

During operation of a fuel cell, some factors can seriously affect the lifespan and performance of the fuel cell. For example, when the output voltage of the fuel cell is at a higher voltage, such as the open-circuit voltage (OCV), the cathode of the fuel cell will have a higher potential, which can adversely affect the carbon support and membrane. In addition, some operating conditions within the fuel cell may produce excessive water and cause flooding, which can hinder the transport and flow of reactants, thereby causing a decrease in the performance and efficiency of the fuel cell. Currently, there is a lack of effective means to solve these issues.

### SUMMARY

To address at least in part the above and other possible problems, examples of the present disclosure provide a method and apparatus for controlling a power transmission device and a fuel cell power system.

According to a first aspect of the present disclosure, a method for controlling a power transmission device is provided. The method comprises: acquiring a sensing signal indicating an output voltage of a fuel cell power supply, the fuel cell power supply providing power to other devices via a power transmission device; comparing the output voltage indicated by the sensing signal to at least one of a high voltage threshold and a low voltage threshold, the voltage range between the high voltage threshold and the low voltage threshold representing a range of expected output voltages of the fuel cell power supply; and in response to the output voltage being not lower than the high voltage threshold, controlling the power transmission device to increase the current input from the fuel cell power supply to the power transmission device, or in response to the output voltage being not higher than the low voltage threshold, controlling the power transmission device to reduce the current input from the fuel cell power supply to the power transmission device.

According to a second aspect of the present disclosure, an apparatus for controlling a power transmission device is provided. The device comprises: an acquisition unit, configured to acquire a sensing signal indicating an output voltage of a fuel cell power supply, the fuel cell power supply providing power to other devices via a power transmission device; a comparison unit, configured to compare the output voltage indicated by the sensing signal to at least one of a high voltage threshold and a low voltage threshold, the voltage range between the high voltage threshold and the low voltage threshold representing a range of expected output voltages of the fuel cell power supply; and a control unit, configured to, in response to the output voltage being not lower than the high voltage threshold, control the power transmission device to increase the current input from the fuel cell power supply to the power transmission device, or in response to the output voltage being not higher than the low voltage threshold, control the power transmission device to reduce the current input from the fuel cell power supply to the power transmission device.

According to a third aspect of the present disclosure, a fuel cell power system is provided. The fuel cell power system comprises: a fuel cell power supply; a power transmission device coupled to the fuel cell power supply; and a control device coupled to the power transmission device and configured to perform the method according to the first aspect.

According to a fourth aspect of the present disclosure, a computer program product is provided. The computing program product is tangibly stored on a non-volatile computer-readable medium and comprises machine-executable instructions that, when executed, cause a machine to execute steps of the method according to the first aspect.

The Summary is provided in part to introduce a selection of concepts in a simplified form, which will be further described in the embodiments below. The Summary is not intended to identify key or primary features of the disclosure, nor is it intended to limit the scope of the disclosure.

### BRIEF DESCRIPTION OF THE DRAWINGS

The exemplary examples of the present disclosure will be described in further detail in conjunction with accompanying drawings in order to further clarify the above-mentioned and other objectives, features, and advantages of the present disclosure, wherein in the exemplary examples of the present disclosure, the same reference number typically represents the same part.

FIG. 1 shows a schematic block diagram of a fuel cell power system according to examples of the present disclosure.

FIG. 2 shows a polarization curve of a fuel cell power supply according to examples of the present disclosure.

FIG. 3 shows a schematic flowchart of a method for controlling a power transmission device according to examples of the present disclosure.

FIG. 4 shows a schematic flowchart of a process for controlling a power transmission device according to examples of the present disclosure.

FIG. 5 shows a graph of power request of a fuel cell power system and output voltage of a fuel cell power supply over time according to examples of the present disclosure.

FIG. 6 shows a schematic block diagram of an apparatus for controlling a power transmission device according to examples of the present disclosure.

### DETAILED DESCRIPTION

The examples of the present disclosure will be described in further detail below with reference to the accompanying drawings. Although examples of the present disclosure are shown in the drawings, it should be understood that the present disclosure can be implemented in various forms and should not be limited to the examples set forth herein. Rather, these examples are provided for the purpose of making the disclosure more thorough and complete and are capable of conveying the scope of the disclosure completely to those skilled in the art. Those skilled in the art can derive alternative technical solutions from the following description without departing from the spirit and scope of protection of the present disclosure.

As used herein, the term “comprise” and variations thereof mean open inclusion, i.e., “including but not limited to.” Unless specifically stated, the term “or” means “and/or.” The term “based on” means “at least partially based on.” The term “an example” means “at least one example.” Other explicit and implicit definitions may be included below.

As previously noted, higher output voltages such as open-circuit voltage and flooding can seriously affect the lifespan and performance of fuel cells. In particular, open-circuit voltage is defined as the maximum voltage produced by a fuel cell at infinite resistance and can be calculated and determined with the current between the anode and cathode of the cell disconnected. When the fuel cell is open circuit or outputs a higher voltage, the cathode is at a high potential and the carbon support is easily corroded, thereby accelerating the dissolution and agglomeration of the catalyst, and the membrane will also be chemically degraded by hydrogen peroxide and free radicals. Long periods of open-circuit or high-output voltage will shorten the useful lifespan of the fuel cell. Therefore, in order to ensure that the fuel cell can achieve a lifespan of 20,000 hours, some products require that the duration of the open-circuit voltage should be limited to less than 100 hours. For flooding, once the pores of the gas diffusion layer are filled with water, the transport of reactants to the catalyst layer is obstructed and the active catalyst site will be covered by water. Additionally, excess water in the fuel cell can cause water bands and columns to form within the flow field channels, which can block or obstruct gas flow. Therefore, flooding can lead to a serious decrease in the overall efficiency and performance of the fuel cell, which can also shorten the lifespan of the cell. Conventional solutions for controlling the output voltage of fuel cells have defects such as slow response speed and poor accuracy. Therefore, they cannot effectively reduce the duration of the open-circuit voltage or prevent the occurrence of flooding.

Examples of the present disclosure provide an improved control scheme for a fuel cell system. By controlling the current input from the fuel cell power supply to the power transmission device, the output voltage of the fuel cell power supply can be quickly and accurately controlled indirectly to maintain the output voltage of the fuel cell power supply within an expected range. Thus, the fuel cell can be prevented from outputting the open-circuit voltage or a high voltage for a long time and flooding can be effectively prevented, thereby improving the lifespan, operating performance, and operating efficiency of the fuel cell.

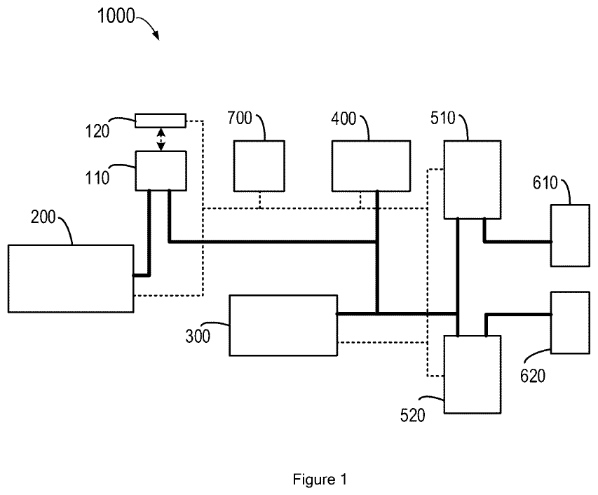

FIG. 1 shows a schematic block diagram of a fuel cell power system 1000 according to examples of the present disclosure. As an example, the fuel cell power system 1000 may be disposed within a vehicle and used to power the vehicle. However, it will be understood that the fuel cell power system 1000 can also be used in other scenarios and is not limited to vehicles. As shown in FIG. 1, the fuel cell power system 1000 comprises a power transmission device 110, a control device 120, and a fuel cell power supply 200. The fuel cell power supply 200 is a device that converts the chemical energy of fuel directly into electrical energy through a chemical reaction. Specifically, the fuel cell power supply 200 may generate electrical energy using a fuel such as hydrogen and an oxidant such as oxygen as reactants. In fuel cells that use hydrogen and oxygen as reactants, the only reaction product is water and no pollutants are generated. The fuel cell power supply 200 may also be referred to as a fuel cell stack or a fuel cell power module, and may comprise a plurality of fuel cell units that may be connected together in series and/or parallel to provide sufficiently high voltage, current, and/or power externally. The power transmission device 110 receives the output power of the fuel cell power supply 200 and converts the power to deliver appropriate voltage and current to other devices. The power transmission device 110 may comprise an appropriate type of power conversion circuit, such as a DC-DC converter. The control device 120 is coupled to the power transmission device 110 and is used to control the power transmission device 110. For example, the control device 120 may control the turning on and off of a power switch in the power transmission device 110 to achieve proper power conversion operations. The control device 120 may be implemented in a variety of ways. For example, the control device 120 may be implemented in the form of a controller with computing and processing capabilities, in the form of analog circuits and/or digital circuits, or in combinations of the various forms. The fuel cell power system 1000 may comprise other devices. For example, where the fuel cell power system 1000 is used in a fuel cell vehicle, the fuel cell power system 1000 may further comprise an energy storage device 300, a charger 400, inverters 510 and 520, motors 610 and 620, and a vehicle control unit 700. The energy storage device 300 may be, for example, a battery pack, and is used to receive and store electrical energy provided by the fuel cell power supply 200 via the power transmission device 110 and/or electrical energy provided from an external power source via the charger 400. The electrical energy of the energy storage device 300 may be provided to the motors 610 and 620 via the inverters 510 and 520 to provide electrical energy to the motors of the vehicle to drive the vehicle. In one example, the electrical energy from the fuel cell power supply 200 and the power transmission device 110 may also be delivered directly to the inverters 510 and 520 and the motors 610 and 620 without passing through the energy storage device 300, thereby driving the motors. In addition, in one example, the motors 610 and 620 may also be electric generators and may be used to feed electrical energy back to the energy storage device 300 via the inverters 510 and 520 when operating in generator mode (e.g., when the vehicle is braking).

The various components in the fuel cell power system 1000 may also be communicatively coupled to one another via wired communication links and/or wireless communication links. For example, the control device 120, the fuel cell power supply 200, the energy storage device 300, the charger 400, the inverters 510 and 520, and the vehicle control unit 700 may be connected via a CAN bus so that communication signals for achieving control and coordination may be transmitted between the various components.

Under certain operating conditions, the fuel cell power supply 200 may be subjected to an open-circuit voltage or a high-output voltage on the output side, or may be subjected to a large requested current. For example, during the startup phase of the fuel cell power supply 200, the requested current of the power transmission device 110 is low, so the output voltage of the fuel cell power supply 200 may remain at or near the open-circuit voltage for a longer period of time, which may shorten the service life of the fuel cell power supply. As the vehicle accelerates, the fuel cell power supply 200 will generate a large amount of water as a reaction product due to the higher requested current, which may lead to flooding and battery polarity reversal, which will also shorten the lifespan of the fuel cell power supply 200 and lead to degradation of performance. During vehicle deceleration, some fuel cell units in the fuel cell power supply 200 may also experience the open-circuit voltage or a relatively high output voltage. Further, the fuel cell power supply 200 is typically provided with a purge phase to remove reaction products such as water generated during the reaction process, thereby preventing the reaction products from affecting subsequent battery operation processes. However, open-circuit voltage and flooding issues may also arise during the purge phase due to delayed and inaccurate current control. These problems affect the lifespan and performance of the fuel cell power supply 200, making it impossible to ensure that the fuel cell power supply 200 has a sufficient lifespan (e.g., 20,000 hours) and good performance.

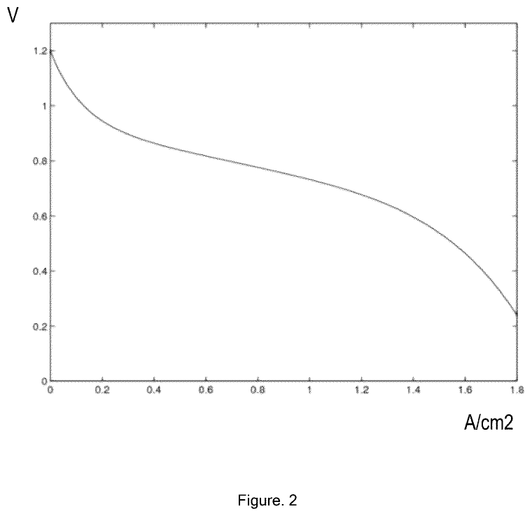

FIG. 2 shows a polarization curve of a fuel cell power supply 200 according to examples of the present disclosure. In FIG. 2, the horizontal axis is the current density (in amperes/square centimeter, A/cm²) of a single fuel cell unit in the fuel cell power supply 200 and the vertical axis is the output voltage (in volts, V) of a single fuel cell unit in the fuel cell power supply 200. As an example, the open-circuit voltage of a single fuel cell unit is defined as being higher than 0.85 V, and the fuel cell power supply 200 may be composed of hundreds of fuel cell units (e.g., 275 fuel cell units) connected in series. It can be seen that the higher the current density of the fuel cell power supply 200, the lower the output voltage, or the lower the current density of the fuel cell power supply 200, the higher the output voltage. That is, there is an inverse relationship between the current output by the fuel cell power supply 200 to the power transmission device 110 and the output voltage. The power transmission device 110 acts as a bridge between the fuel cell power supply 200 and other high-voltage devices and is capable of providing electrical energy from the fuel cell power supply 200 to a high-voltage interface (e.g., the energy storage device 300). Research has shown that the power transmission device 110 has a significant impact on the performance and energy utilization efficiency of the fuel cell power supply 200, and the output voltage of the fuel cell power supply 200 can be indirectly controlled by actively controlling the requested current of the power transmission device 110, which helps to ensure the service life and operating performance of the fuel cell.

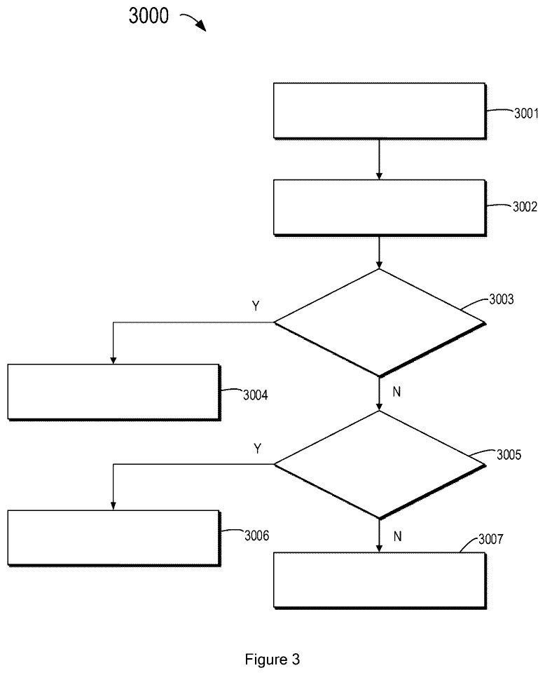

FIG. 3 shows a schematic flowchart of a method 3000 for controlling a power transmission device 110 according to examples of the present disclosure. The method 3000 may be implemented in the scenario in FIG. 1 and executed by the control device 120. However, it will be understood that in some cases, the method 3000 may also be executed by a controller other than the control device 120. For example, when the vehicle control unit 700 or other control units in the system are capable of controlling the power transmission device 110 and have a sufficiently fast response speed, it may also be executed by the vehicle control unit 700 or other control units in the system. For purposes of discussion, the method 3000 is described below with reference to FIGS. 1 and 2.

At block 3001, the control devices 120 obtains a sensing signal indicating an output voltage of the fuel cell power supply 200. As an example, a voltage-sensing device for detecting the output voltage of the fuel cell power supply 200 may be provided on the fuel cell power supply 200, the power transmission device 110, or a line between the two. As such, the control device 120 may receive a sensing signal from the voltage-sensing device and sample the sensing signal to achieve real-time monitoring of the output voltage.

At block 3002, the control device 120 compares the output voltage indicated by the sensing signal to at least one threshold of a high-voltage threshold and a low-voltage threshold, the voltage range between the high-voltage threshold and the low-voltage threshold representing the range of the expected output voltages of the fuel cell power supply 200. As an example, depending on the safety and performance needs of the system and based on the current operating phase, the control device 120 may pre-set the high-voltage threshold and the low-voltage threshold or acquire the high-voltage threshold and the low-voltage threshold from other components (e.g., the fuel cell power supply 200). For example, to avoid output voltage from being too high and approaching the open-circuit voltage, the high-voltage threshold can be set to 225 V and the low-voltage threshold setting can be set to 195 V to avoid flooding. As such, the voltage range between 195 V and 225 V represents the range of expected output voltages of the fuel cell power supply 200.

At block 3003, the control device 120 determines whether the output voltage is not less than the high-voltage threshold.

At block 3004, if the output voltage is not less than the high-voltage threshold, the control device 120 controls the power transmission device 110 to increase the current input from the fuel cell power supply 200 to the power transmission device 110. As previously noted, due to the inverse relationship between the output voltage and current of the fuel cell power supply 200, when the output voltage is too high and approaches and reaches the open-circuit voltage, the current input from the fuel cell power supply 200 to the power transmission device 110 can be increased by controlling the power transmission device 110 to suppress and reduce the output voltage of the fuel cell power supply 200 to maintain the output voltage within the expected output voltage range.

At block 3005, if the output voltage is lower than the high-voltage threshold, the control device 120 determines whether the output voltage is not higher than the low-voltage threshold.

At block 3006, if the output voltage is not higher than the low-voltage threshold, the control device 120 controls the power transmission device to reduce the current input from the fuel cell power supply 200 to the power transmission device 110. As previously noted, due to the inverse relationship between the output voltage and current of the fuel cell power supply 200, when the current of the fuel cell power supply 200 and the power transmission device 110 is too high, resulting in an excessively low output voltage and an increased risk of flooding, the power transmission device 110 can be controlled to reduce the current input from the fuel cell power supply 200 to the power transmission device 110, thereby increasing the output voltage of the fuel cell power supply 200 and maintaining the output voltage within the expected output voltage range. As a result, the risk of flooding of the fuel cell power supply is reduced or eliminated.

At block 3007, if the output voltage is lower than the high-voltage threshold and higher than the low-voltage threshold, the control device 120 does not adjust or change the current input from the fuel cell power supply 200 to the power transmission device 110. Specifically, if the output voltage is lower than the high-voltage threshold value and higher than the low-voltage threshold, this means that the output voltage of the fuel cell power supply 200 is within the expected voltage range, and therefore the control of the power transmission device 110 need not be adjusted.

It will be understood that when the output voltage indicated by the sensing signal is compared to at least one threshold of the high-voltage threshold and the low-voltage threshold, the output voltage may be compared first to the high-voltage threshold, or the output voltage may be compared first to the low-voltage threshold, or both comparisons can be performed simultaneously. The present disclosure does not limit the order in which thresholds are compared.

In some examples of the present disclosure, if the output voltage is not lower than the high-voltage threshold, the control device 120 increases the current expected requested current and controls the power transmission device 110 based on the increased expected requested current; and if the output voltage is not higher than the low-voltage threshold, the control device 120 decreases the current expected requested current and controls the power transmission device 110 based on the decreased expected requested current. The expected requested current indicates the current that the power transmission device is expected to input from the fuel cell power supply 200 or the current that the power transmission device 110 is expected to output to other devices.

In particular, the power transmission device 110 may be a current-controlled circuit, and the control device 120 may control the power transmission device 110 to generate the expected requested current on either the input or output side of the power transmission device 110 based on the expected requested current. For example, the control device 120 may implement closed-loop control of the current based on the expected requested current and current feedback. When the output voltage of the fuel cell power supply 200 is too high, the control device 120 may increase the expected requested current to increase the current on the input or output side of the power transmission device 110 to decrease the output voltage of the fuel cell power supply 200. When the current of the fuel cell power supply 200 is too high and caused the output current to be too low, the control device 120 may decrease the expected requested current to decrease the current on the input or output side of the power transmission device 110 to increase the output voltage of the fuel cell power supply 200.

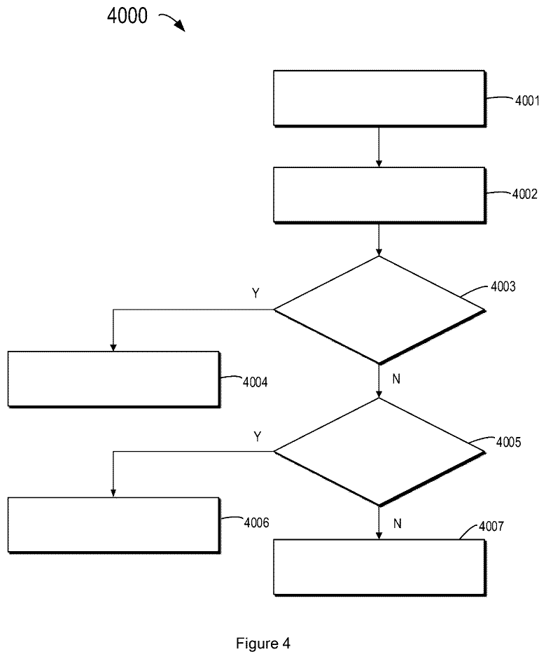

FIG. 4 shows a schematic flowchart of a process 4000 for controlling a power transmission device 110 in some examples of the present disclosure. The process 4000 may be performed, e.g., prior to step 5001 in the method 3000.

At block 4001, the control device 120 receives a command signal indicating an expected requested current for controlling the power transmission device 110 to input a current corresponding to the expected requested current from the fuel cell power supply 200 or to output a current corresponding to the expected requested current to other devices. As an example, the fuel cell power supply 200 may receive a power request signal from the vehicle control unit 700 and determine an expected requested current based on the power request signal. After determining the expected requested current, the fuel cell power supply 200 may send a signal indicating the expected requested current to the control device 120 so that the control device 120 controls the power transmission device 110 to generate the expected current based on the received signal, thereby obtaining power corresponding to the power request signal from the fuel cell power supply 200 to provide to other devices. In addition, the control device 120 can also receive instructions indicating the expected requested current from other components. For example, the vehicle control unit 700 can determine the expected requested current based on the state of the fuel cell and send instructions indicating the expected requested current from the vehicle control unit 700 to the control device 120. Alternatively, the control device 120 may also determine the expected requested current based on signals from the vehicle control unit 700 and the fuel cell power supply 200 (e.g., signals indicating the status and power request of the fuel cell power supply).

At block 4002, the control device 120 compares the received expected requested current to at least one threshold of a low-current threshold and a high-current threshold, the low-current threshold and the high-current threshold being associated with a high-voltage threshold and a low-voltage threshold, respectively. As an example, based on the relationship between the output voltage and current of the fuel cell power supply 200 (such as the relationship shown in FIG. 2), the control device 120 can calculate and determine the low-current threshold corresponding to the current high-voltage threshold and calculate and determine the high-current threshold corresponding to the current low-voltage threshold. Thus, an expected current range can be obtained, and whether the expected requested current is within the expected current range can be determined by threshold comparison.

At block 4003, it is determined whether the received expected requested current is higher than the high-current threshold.

At block 4004, if the received expected requested current is higher than the high-current threshold, the control device 120 adjusts the expected requested current to be equal to the high-current threshold.

At block 4005, it is determined whether the received expected requested current is lower than the low-current threshold.

At block 4006, if the received expected requested current is lower than the low-current threshold, the control device 120 adjusts the expected requested current to be equal to the low-current threshold.

At block 4007, if the received expected requested current is not higher than the high-current threshold and is not lower than the low-current threshold, the control device 120 will not adjust or change the expected requested current.

It will be understood that when comparing the expected requested current to at least one threshold of the high-current threshold and the low-current threshold, the expected requested current may be compared first to the high-current threshold, or the expected requested current may be compared first to the low-current threshold, or both comparisons can be performed simultaneously. The present disclosure does not limit the order in which thresholds are compared.

Additionally, the process 4000 may be performed first to limit the expected requested current to a safe range, and then the steps of monitoring voltage and adjusting current based on threshold comparison in the method 3000 may be performed. In this way, before controlling the power transmission device 110 according to the received expected requested current, the control device 120 can adjust the expected requested current to limit the expected requested current to a certain current range in advance, thereby more effectively avoiding flooding and open-circuit voltage problems caused by excessively high or low requested current during the control process. For example, sudden acceleration and deceleration as well as sudden increases and decreases in the power request may occur during the driving of the vehicle, which may cause the expected requested current for the power transmission device 110 to also increase and decrease sharply. By limiting the expected requested current in advance, the expected requested current can be maintained within a certain range without sudden changes in the power request, thereby more effectively preventing the fuel cell from being subjected to the open-circuit voltage for a long time or being flooded.

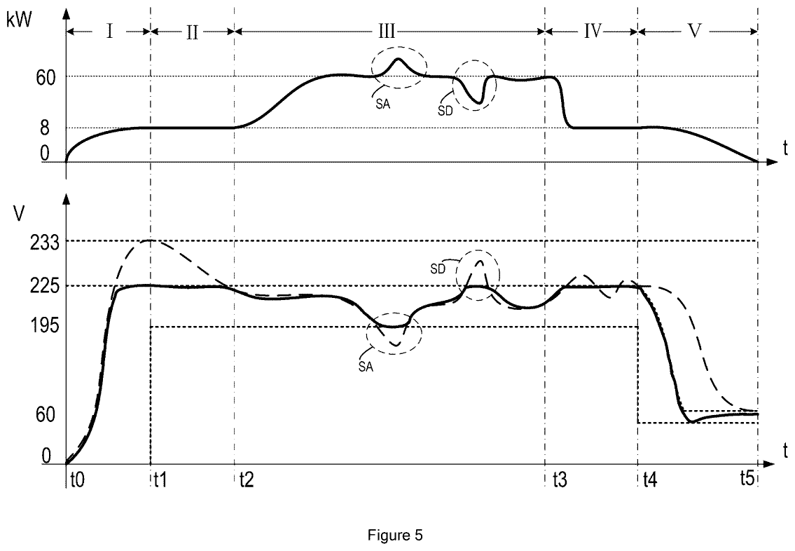

FIG. 5 shows a graph of power request of a fuel cell power system 1000 and output voltage of a fuel cell power supply 200 over time according to examples of the present disclosure. The top figure in FIG. 5 is a graph of power request of the fuel cell system 1000 changing over time, and the bottom figure of FIG. 5 is a graph of output voltage of the fuel cell power supply 200 changing over time. The vertical axis of the top figure is the power requested by the fuel cell system 1000 (in kilowatts kW), the vertical axis of the bottom figure is the output voltage of the fuel cell power supply 200 (in volts V), and the horizontal axes of both figures are time. The operation process of the fuel cell power system 1000 for a vehicle may be divided into five phases, i.e., the ignition phase (I t0 to t1), idle phase II (t1-t2), driving phase III (t2 to t3), idle phase IV (t3 to t4), and shutdown phase V (t4 to t5). In the ignition phase I (t0 to t1), the fuel cell vehicle is turned on and started, and the power request of the vehicle gradually increases from 0 kW to 8 kW. In the idle phase II (t1 to t2), the vehicle is activated and in the idle state without driving, and the power request is maintained at 8 kW. In the driving phase III (t2 to t3), the vehicle enters the driving state and the power request gradually rises from 8 kW to 60 kW and fluctuates with acceleration and deceleration. In the idle phase IV (t3 to t4), the vehicle is again in the idle state without driving, and the power request drops to 8 kW. In the shutdown phase V (t4 to t5), the vehicle is shut down, and the power request of the vehicle gradually drops from 8 kW to 0 kW.

The operation process of the fuel cell power supply 200 can be divided into five phases corresponding to the five phases described above, i.e., the startup phase I (t0 to t1), idle phase II (t1 to t2), run phase III (t2 to t3), purge phase IV (t3 to t4), and power-down phase V (t4 to t5). The startup phase is a transition phase in which the fuel cell starts up from the deactivated state and has not yet reached a normal operating state. In the startup phase I (t0 to t1), the fuel cell power supply 200 is started and the output voltage gradually increases. The idle phase is a phase in which the fuel cell is in a low-load or no-load state, such as when a fuel cell vehicle is waiting to go on the road after starting or waiting for a traffic light at an intersection. In the idle speed phase II (t1 to t2), the fuel cell power supply 200 is in the idle state. The run phase is a phase in which a fuel cell that has completed startup normally outputs power, such as when a fuel cell vehicle is normally driving on the road. In the run phase II (I t2 to t3), the fuel cell power supply 200 is in the running state and undergoes voltage fluctuations as the vehicle accelerates and decelerates. The purge phase is the stage in which the fuel cell is preparing to power down and reactants are removed. In the purge phase IV (t3 to t4), the fuel cell power supply 200 performs a purge operation to remove water as a reaction product. The power-down phase is a transition phase in which the fuel cell is shut down and powered off. In the power-down phase V (t4 to t5), the fuel cell power supply 200 performs a power-down operation and needs to reduce the output voltage to below a safe voltage (e.g., below 60 V).

In some examples of the present disclosure, the high-voltage threshold is determined based on the open-circuit output voltage of the fuel cell power supply 200 during at least one of the startup phase I, idle phase II, run phase III, and purge phase IV of the fuel cell power supply 200. Specifically, in the startup phase I, idle phase II, run phase III, and purge phase IV, the high-voltage threshold may be set according to the magnitude of the open-circuit output voltage. For example, when open-circuit voltage is 233 V, the high-threshold voltage can be set to 225 V to maintain the output voltage of the fuel cell power supply 200 below 225 V, thereby ensuring in phases I to IV that the output voltage of the fuel cell power supply 200 will not approach or reach the open-circuit voltage of 233 V and avoiding damage to the fuel cell from the open-circuit voltage or high-output voltage.

In some examples of the present disclosure, the high-voltage threshold is a gradually decreasing value during the power-down phase V of the fuel cell power supply 200. As previously noted, the output voltage of the fuel cell power supply 200 can be accurately and quickly controlled by controlling the current of the power transmission device 110. As such, by setting a gradually decreasing high-voltage threshold, the output voltage may be made to drop more quickly below a safe voltage (e.g., 60 V) in the power-down phase V. In contrast, during the traditional power-down process, it takes a long time to reduce the voltage of the fuel cell to below the safe voltage. As an example, the high-voltage threshold may gradually drop from 225 V to 60 V during the power-down phase V, thereby enabling the output voltage of the fuel cell power supply 200 to drop quickly below the safe voltage under the limitation of the high-voltage threshold.

In some examples of the present disclosure, the low-voltage threshold is determined based on the output voltage that causes flooding of the fuel cell power supply 200 during at least one of the idle phase II, run phase III, and purge phase IV of the fuel cell power supply 200. In particular, in the idle phase II, run phase III, and purge phase IV, excessively high power requests may occur, resulting in excessive current and flooding. For example, when the vehicle is abruptly accelerating in the run phase III, the fuel cell power supply 200 may generate excessive water due to excessive current. According to the inverse relationship shown in FIG. 2, the output voltage of the fuel cell power supply 200 becomes too low when the current is too large. Thus, a low-voltage threshold can be set according to the excessively low voltage that causes flooding, thereby preventing excessive current that causes flooding from occurring by limiting the output voltage to be not lower than the low-voltage threshold. In one example, the low-voltage threshold is set to 195 V, whereby the voltage of the fuel cell may be maintained above 195 V during the idle phase II, run phase III, and purge phase IV. In this way, the adverse effects of flooding on the lifespan and performance of the fuel cell can be prevented. Furthermore, in one example, in the startup phase I of the fuel cell power supply 200, the low-voltage threshold may be set to 0 V, and in the power-down phase V of the fuel cell power supply 200, the low-voltage threshold may be set to 60 V. The fuel cell in the startup phase I and the power-down phase V has just started or is about to be shut down, so the voltage is usually low. The low-voltage threshold may be set to a relatively low voltage level, or a low-voltage threshold may not be set, to avoid affecting the operation of the fuel battery power supply 200 during the startup phase and the power-down phase.

In some examples of the present disclosure, the control device 120 may receive a command signal from the fuel cell power supply 200 indicating a high-voltage threshold and/or a low-voltage threshold. Thus, the control device 120 may adjust and set the high-voltage threshold and/or the low-voltage threshold based on the actual state and phase of the fuel cell power supply 200 and the vehicle. Alternatively, the control device 120 may also obtain command signals indicating a high-voltage threshold and/or a low-voltage threshold from other components when the actual status and phase of the fuel cell power supply 200 and the vehicle are known to other components, e.g., such command signals may be received from the vehicle control unit 700.

The process by which the control device 120 controls the power transmission device 110 in phases I to V will be briefly described below with reference to FIG. 5, wherein the dashed line in the bottom figure of FIG. 5 shows the change curve of the output voltage of the fuel cell power supply 200 with a conventional approach, and the solid line curve in the bottom figure of FIG. 5 shows the change curve of the output voltage of the fuel cell power supply 200 with the improved approach according to examples of the present disclosure.

In the startup phase I of the fuel cell power supply 200, the power request of the vehicle is low, and therefore the expected requested current of the power transmission device 110 is also relatively low. The control device 120 monitors the output voltage of the fuel cell power supply 200 in real time. If the output voltage of the fuel cell power supply 200 reaches or is about to exceed the high-voltage threshold, the control device 120 may control the power transmission device to change the current input from the fuel cell power supply 200. For example, the control device 120 may achieve the purpose of increasing the current by increasing the expected requested current. As such, this active protection implemented by the power transmission device 110 and the control device 120 can maintain the output voltage of the fuel cell power supply 200 below 225 V without approaching or reaching the open-circuit voltage of 233 V.

In the idle phase II of the fuel cell power supply 200, the power request is generally maintained at a low level. The active protection implemented by the power transmission device 110 and the control device 120 can ensure that the output voltage is maintained within a safe range between 195 V and 225 V.

In the run phase III of the fuel cell power supply 200, sudden acceleration SA and sudden deceleration SD occur. By regulating and limiting the output voltage, it is possible to avoid flooding caused by excessively low voltage and excessively high current during sudden acceleration SA and to avoid excessively high voltage close to the open-circuit voltage during sudden deceleration SD. In one example, the process 4000 may be performed in the run phase III, whereby the expected requested current may be appropriately limited in advance upon receipt to ensure that the expected requested current is within a certain current range, thereby more effectively reducing the risk of open-circuit voltage and flooding.

The active protection implemented by the power transmission device 110 and the control device 120 in the purge phase IV of the fuel cell power supply 200 can accurately control the output voltage of the fuel cell power supply 200 to prevent open-circuit voltage and flooding caused by delays and inaccurate expected requested current.

In the power-down phase V of the fuel cell power supply 200, the voltage control performed by the power transmission device 110 and the control device 120 can cause the output voltage of the fuel cell power supply 200 to drop quickly and accurately below a safe voltage (e.g., 60 V), thereby enabling the fuel cell power supply 200 to be in a safe state as quickly as possible during the power-down process.

It can be seen that compared with the conventional solution, the improved solution according to examples of the present disclosure can effectively limit the output voltage of the fuel cell to a voltage range far lower than the open-circuit voltage by controlling the power transmission device and maintain the output voltage in a higher voltage range to avoid flooding during the dynamic operation of the fuel cell, thereby improving the service life and performance of the fuel cell. In addition, the voltage of the fuel cell can be reduced to below the safe voltage as quickly as possible during the power-down process, thereby improving the safety of the system.

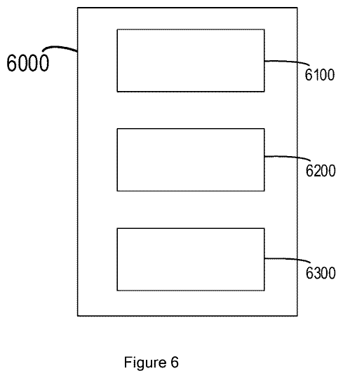

FIG. 6 shows a schematic block diagram of an apparatus 6000 for controlling a power transmission device 110 according to examples of the present disclosure. The apparatus 6000 may be implemented as the control device 120 of FIG. 1. As shown in FIG. 6, the apparatus 6000 comprises an acquisition unit 6100. The acquisition unit 6100 is configured to acquire a sensing signal indicating the output voltage of the fuel cell power supply 200, the fuel cell power supply 200 providing power to other devices via the power transmission device 110. The control device 6000 further comprises a comparison unit 6200. The comparison unit 6200 is configured to compare the output voltage indicated by the sensing signal to at least one threshold of a high-voltage threshold and a low-voltage threshold, the voltage range between the high-voltage threshold and the low-voltage threshold representing the range of expected output voltages of the fuel cell power supply 200. In addition, the control device 6000 further comprises a control unit 6300. The control unit 6300 is configured to control the power transmission device 110 to increase the current input from the fuel cell power supply 200 to the power transmission device 110 in response to the output voltage being not lower than the high-voltage threshold or to control the power transmission device 110 to decrease the current input from the fuel cell power supply 200 to the power transmission device 110 in response to the output voltage being not higher than the low-voltage threshold.

Those skilled in the art will appreciate that the various steps of the method of the present disclosure above can be implemented by a general-purpose computing device. They can be concentrated on a single computing device or distributed on a network composed of multiple computing devices. Optionally, they can be implemented using program code executable by a computing device so that they can be stored in a storage device and executed by the computing device, or they can be made into individual integrated circuit modules, or multiple modules or steps therein can be made into a single integrated circuit module for implementation. As such, the present disclosure is not limited to any particular hardware and software combination.

It will be understood that although a number of apparatuses or sub-apparatuses of the device are mentioned in the above detailed description, such a division is merely exemplary and not mandatory. In fact, the features and functions of two or more apparatuses described above may be embodied in one apparatus according to examples of the present disclosure. Conversely, the features and functions of one apparatus described above may be further divided and embodied by multiple devices.

The foregoing are merely optional examples of the present disclosure and are not intended to limit the present disclosure, which may be subject to various modifications and variations to those skilled in the art. Any modifications, equivalent substitutions, improvements, etc. made in the spirit and principles of the present disclosure shall be included within the scope of protection of the present disclosure.

What is claimed is:

1. A method for controlling a power transmission device, comprising:
acquiring a sensing signal indicating an output voltage of a fuel cell power supply, the fuel cell power supply providing power to other devices via the power transmission device;
comparing the output voltage indicated by the sensing signal to at least one threshold of a high-voltage threshold and a low-voltage threshold, the voltage range between the high-voltage threshold and the low-voltage threshold representing the range of the expected output voltages of the fuel cell power supply; and
controlling the power transmission device to increase the current input from the fuel cell power supply to the power transmission device in response to the output voltage being not lower than the high-voltage threshold or controlling the power transmission device to decrease the current input from the fuel cell power supply to the power transmission device in response to the output voltage being not higher than the low-voltage threshold.

2. The method according to claim 1, wherein the high-voltage threshold is determined based on the open-circuit output voltage of the fuel cell power supply during at least one of a startup phase, an idle phase, a run phase, and a purge phase of the fuel cell power supply.

3. The method according to claim 1, wherein the high-voltage threshold is a gradually decreasing value during the power-down phase of the fuel cell power supply.

4. The method according to claim 1, wherein the low-voltage threshold is determined based on the output voltage that causes flooding of the fuel cell power supply during at least one of an idle phase, a run phase, and a purge phase of the fuel cell power supply.

5. The method according to claim 1, wherein controlling the power transmission device to increase the current input from the fuel cell power supply to the power transmission device comprises:
increasing the current expected requested current in response to the output voltage being not lower than the high-voltage threshold, the expected requested current indicating the current expected to be input from the fuel cell power supply by the power transmission device or the current expected to be output from the power transmission device to other devices; and
controlling the power transmission device based on the increased expected requested current.

6. The method according to claim 1, wherein controlling the power transmission device to decrease the current input from the fuel cell power supply to the power transmission device comprises:
decreasing the current expected requested current in response to the output voltage being not higher than the low-voltage threshold, the expected requested current indicating the current expected to be input from the fuel cell power supply by the power transmission device or the current expected to be output from the power transmission device to other devices; and
controlling the power transmission device based on the decreased expected requested current.

7. The method according to claim 1, further comprising:
receiving a command signal indicating an expected requested current for controlling the power transmission device to input a current corresponding to the expected requested current from the fuel cell power supply or to output a current corresponding to the expected requested current to other devices;
comparing the received expected requested current to at least one threshold of a low-current threshold and a high-current threshold, the low-current threshold and the high-current threshold being associated with a high-voltage threshold and a low-voltage threshold, respectively; and
adjusting the expected requested current to be equal to the high-current threshold in response to the received expected requested current being higher than the high-current threshold, or adjusting the expected requested current to be equal to the low-current threshold in response to the received expected requested current being lower than the low-current threshold.

8. The method according to claim 7, wherein in the run phase of the fuel cell power supply, an operation is performed to compare the received expected requested current to at least one threshold of the low-current threshold and the high-current threshold, and an operation is performed to adjust the expected requested current based on the comparison result.

9. A device for controlling a power transmission device, comprising:
an acquisition unit configured to acquire a sensing signal indicating an output voltage of a fuel cell power supply, the fuel cell power supply providing power to other devices via the power transmission device;
a comparison unit configured to compare the output voltage indicated by the sensing signal to at least one threshold of a high-voltage threshold and a low-voltage threshold, the voltage range between the high-voltage threshold and the low-voltage threshold representing the range of the expected output voltages of the fuel cell power supply; and
a control unit configured to control the power transmission device to increase the current input from the fuel cell power supply to the power transmission device in response to the output voltage being not lower than the high-voltage threshold or to control the power transmission device to decrease the current input from the fuel cell power supply to the power transmission device in response to the output voltage being not higher than the low-voltage threshold.

10. A fuel cell power system, comprising:
a fuel cell power supply;
a power transmission device coupled to the fuel cell power supply; and
a control device coupled to the power transmission device and configured to perform the method according to claim 1.

11. The fuel cell power system according to claim 10, further comprising:
an energy storage device and motors coupled to the power transmission device.

12. A computer program product, the computer program product being tangibly stored on a non-volatile computer-readable medium and comprising machine-executable instructions, the machine-executable instructions, when executed, causing a machine to execute steps of the method according to claim 1.
